(19) United States
(12) Patent Application Publication
(10) Pub. No.: US 2011/0082906 A1
(43) Pub. Date: Apr. 7, 2011

(54) INSTANT MESSAGING TRANSMISSION AND DISPLAY

(75) Inventors: Michael P. Kreig, Poughkeepsie, NY (US); Thomas E. Murphy, JR., Poughkeepsie, NY (US)

(73) Assignee: INTERNATIONAL BUSINESS MACHINES CORPORATION, Armonk, NY (US)

(21) Appl. No.: 12/572,667

(22) Filed: Oct. 2, 2009

(51) Int. Cl. G06F 15/16

(52) U.S. Cl. 709/206

(57) ABSTRACT

A method of enhanced message transmission includes receiving an anchor message request, the anchor message request referring to a message for transmission, embedding a logical anchor in the message for transmission to form an anchored message, the logical anchor referring to a portion of the message for transmission to be anchored inside or outside a displayable area of a messaging client, and transmitting the anchored message.

### BACKGROUND

1. Field

This application relates to instant messaging, and in particular, to transmission and display of instant messages within a user interface.

2. Background

Generally, if transmitting a message over an instant messaging or other messaging service, the message is displayed at a receiving instant messaging (IM) client according to the format required by the receiving IM client. If the received message is of a length where the entire message cannot be displayed at the receiving IM client's user interface, the message view is truncated such that only a portion, the last portion, of the message is fully displayed. In order to view the preceding portion(s) of the message, a receiving user at the receiving IM client must “scroll” up to view a preceding or beginning portion.

It follows that if the information contained in the preceding or truncated portions of the displayed message are important or necessary to view prior to the displayed portions, the receiving user may be confused or may omit reading the message completely.

Thus, it may be beneficial to provide enhancements to typical IM clients such that messages are displayed according to a desired format, thereby ensuring or increasing the likelihood that a receiving user has the ability to read preceding portions of a message.

### SUMMARY

According to at least one example embodiment, a method of enhanced message transmission includes receiving an anchor message request, the anchor message request referring to a message for transmission, embedding a logical anchor in the message for transmission to form an anchored message, the logical anchor referring to a portion of the message for transmission to be anchored inside or outside a displayable area of a messaging client, and transmitting the anchored message.

According to another example embodiment, a method of enhanced message receipt includes receiving a message at a messaging client, determining if a logical anchor is embedded within the received message, the logical anchor referring to a portion of the received message to be anchored inside or outside a displayable area of the messaging client, and displaying the received message in response to the determining.

According to another example embodiment, a computer readable storage medium includes computer executable instructions that, when executed on a computer processor, direct the computer processor to perform a method of enhanced message transmission. The method includes receiving an anchor message request, the anchor message request referring to a message for transmission, embedding a logical anchor in the message for transmission to form an anchored message, the logical anchor referring to a portion of the message for transmission to be anchored inside or outside a displayable area of a messaging client, and transmitting the anchored message.

According to another example embodiment, a computer readable storage medium includes computer executable instructions that, when executed on a computer processor, direct the computer processor to perform a method of enhanced message receipt. The method includes receiving a message at a messaging client, determining if a logical anchor is embedded within the received message, the logical anchor referring to a portion of the received message to be anchored inside or outside a displayable area of the messaging client, and displaying the received message in response to the determining.

### BRIEF DESCRIPTION OF THE SEVERAL VIEWS OF THE DRAWINGS

FIG. 1 is a diagram representing a user interface of a conventional instant messaging (IM) client;

FIG. 2 is a diagram of a user interface of an IM client, according to an example embodiment;

FIG. 3 is a diagram of a user interface of an IM client, according to an example embodiment;

FIG. 4 is a method of transmitting an instant message, according to an example embodiment;

FIG. 5 is a method of receiving an instant message, according to an example embodiment; and

FIG. 6 is a computing apparatus, according to an example embodiment.

### DETAILED DESCRIPTION

Detailed illustrative embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Further, as used herein the terms “Instant Messaging client,” “IM client,” “messaging client,” or other similar phrases shall refer to any messaging application existing or being executed on a device, whether a computer, laptop, personal computer, mobile phone, or other suitable device capable of executing computer code portions or the methodologies described herein. Additionally, these terms shall not be limited to particular Instant Messaging clients, but to all messaging services to which the present invention is applicable, for example, short message service (SMS) clients/cell phones, multimedia message service (MMS) clients/cell phones, remote blog services (e.g., message transmitted to web-blog for display of message), remote web-post services (e.g., message transmitted to website or social networking site for display of message), or any other suitable messaging system or client.

Hereinafter, example embodiments will be described with reference to the attached drawings.

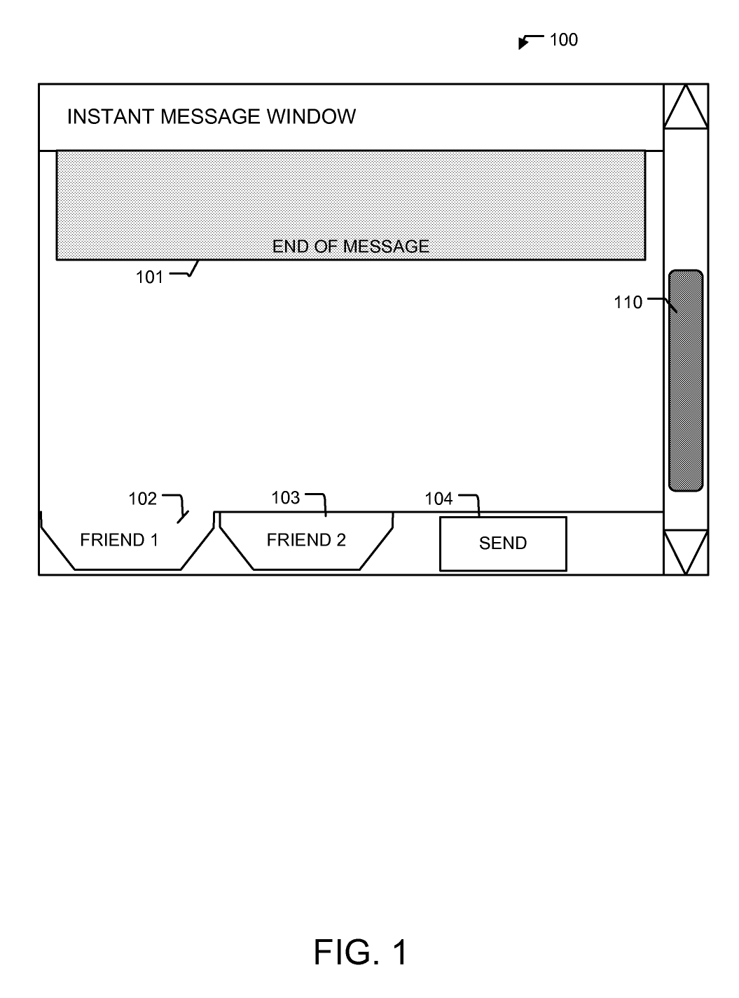

FIG. 1 is a diagram representing a user interface of a conventional instant messaging (IM) client. The user interface 100 may include an instant message window for display of a message 101. As illustrated, the message 101 is truncated or “cut off” such that the instant message window only displays the bottom portion of the message 101. This may be due to the length of the message 101. For example, if the length of message 101 is of a size greater than the available viewing area of the instant message window, it is necessary to truncate the message such that only a portion is displayed. A user of the user interface 100 may utilize the scroll bar 110 to “scroll up” the instant message window to view preceding portions of the message 101.

The user interface 101 may further include a plurality of tabs or selectable view panes 102-103 to allow active selection of separate instant messaging connections. For example, if tab 102 is selected, a first connection to “Friend 1” may be activated or displayed. Similarly, if tab 103 is selected, a second connection to “Friend 2” may be activated or selected. Furthermore, a user of the user interface 100 may depress or select the SEND button 104 such that a current or typed message is transmitted to an active connection.

As described above, conventional IM clients and respective interfaces may truncate displayed messages such that only a bottom or end of the message is displayed, depending upon message length. Additionally, conventional IM clients and respective interfaces may truncate unread messages entirely if newer messages are received which take up portions of the displayable area of user interfaces of these clients. Furthermore, if messages include subject matter intended to be displayed first, for example a preamble to a joke or mathematical question, conventional clients may truncate these portions thereby negating the intended readability of the message. For example, a receiving user may view a joke's punch-line or solution to a problem/question before scrolling upward to view the joke's premise. However, example embodiments of the present invention provide novel features which overcome these drawbacks.

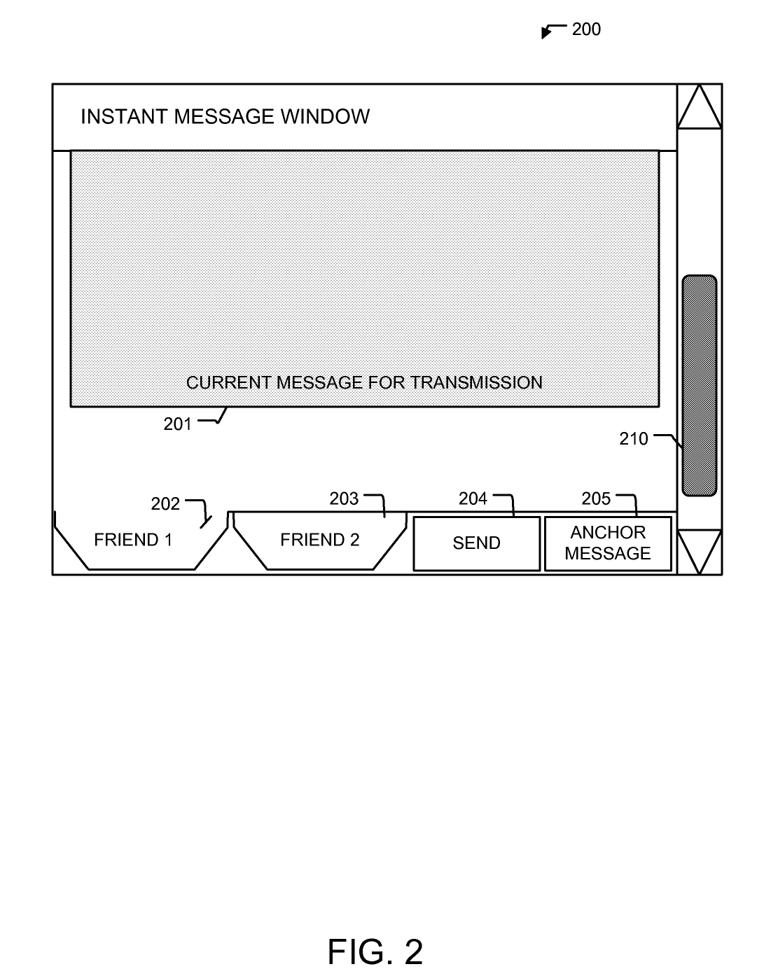

FIG. 2 is a diagram of a user interface of an IM client, according to an example embodiment. The user interface 200 includes an instant message window which displays both received messages and message being compiled/typed by a user of the user interface 200. As illustrated, message 201 is a current message established by the user and ready for transmission. Through selection of the send button 204, the message may be transmitted to an active user selected through one of tabs 202-203. For example tabs 202-203 may be somewhat similar to tabs 102-103 described above. According to FIG. 2, message 201 is longer or greater in length than the displayable portion of the instant message window. Thus it is implied that a receiving IM client may truncate the message. Therefore, the user interface 200 provides an alternate transmit button 205 labeled “ANCHOR MESSAGE”.

The button 205, upon selection, may embed a logical anchor decipherable by the receiving IM client such that the receiving IM client displays the message 201 from an anchor point, for example the upper portion, of message 201. More clearly, versus truncating the upper portion of the message 201, a non-anchored portion of the message 201 is truncated such that beginning portions or anchored portions of message 201 are displayed first. In this manner, a user of the receiving IM client may read the anchored portion of the message 201 before subsequent portions.

It is noted that although user interface 200 has been illustrated as including both buttons 204 and 205, send button 204 may be omitted entirely with button 205 serving as an “anchor message+send” button, a “send to top” button (e.g., always anchors top of message), or other suitable send and anchor configuration. Alternatively, button 205 may be omitted entirely and button 204 may be configured to embed a logical anchor. Such a configuration may be facilitated through “user options” provided in the user interface 200. For example, a checkbox or other selectable interface portions may be made accessible to a user desiring the use of logical anchors in his/her messages.

Hereinafter, messages transmitted with logical anchors are described more fully with reference to a user interface of a user receiving a message.

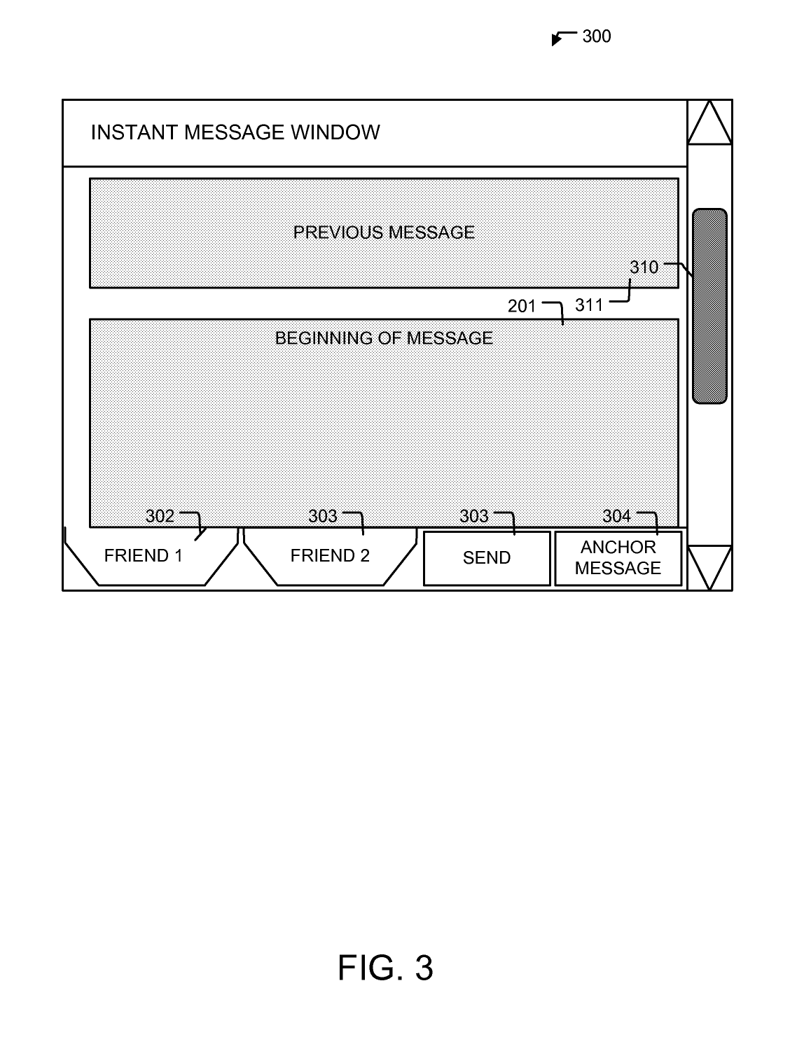

FIG. 3 is a diagram of a user interface of an IM client, according to an example embodiment. The user interface 300 includes an instant message window which displays both received messages and messages being compiled/typed by a user of the user interface 300. As illustrated, message 311 is a message previously received or transmitted using user interface 300. The message 311 is truncated due to an additional message 201 being displayed there-below, a user using scroll bar 310 to “scroll down” the displayable area of the interface 300, or any other suitable situation in which only a portion of message 311 is displayable.

Message 201 is a current message received by the user and displayed according to an example embodiment of the present invention. The message 201 has been received from an active user selected through tab 302. For example tabs 302-303 may be somewhat similar to tabs 102-103 and 202-203 described above. According to FIG. 3, message 201 is longer or greater in length than the displayable portion of the instant message window. However, as also illustrated, an upper or anchored portion of the message has been displayed. For example, the message 201, transmitted from user interface 200, includes a logical anchor configured to “anchor” the first line of the message 201 in the displayable area of user interface 300. Furthermore, subsequent messages received while the logical anchor is in place are received but appended after the message 201. Therefore, in order for remaining portions of message 201 and subsequent messages received to be viewed at user interface 300, a user may select and “scroll down” the viewable area of user interface 300 using scroll bar 310. This may be somewhat similar to suspension of any automatic “scrolling” of incoming messages on the displayable area of user interface 300.

As further illustrated, user interface 300 includes transmit buttons 304 and 305. The buttons 304 and 305 may be somewhat similar to buttons 204-205 described with reference to FIG. 2, and therefore exhaustive description will be omitted herein for the sake of brevity. However, it is noted that although user interface 300 has been illustrated as including both buttons 304 and 305, button 304 may be omitted entirely. Alternatively, button 305 may be omitted entirely and button 304 may be configured to embed a logical anchor. Such a configuration may be facilitated through “user options” provided in the user interface 300. For example, a checkbox or other selectable interface portions may be made accessible to a user desiring the use of logical anchors in his/her messages.

With regards to the logical anchor described in reference to FIGS. 2-3 the following detailed description is provided. The logical anchor described may be a code portion transmitted alongside or embedded within a message being transmitted from an IM client. For example, the logical anchor may be a configurable code portion referencing a character string, line, or particular portion of the message being transmitted. The logical anchor may be configured at a transmitting IM client, a receiving IM client, or any combination thereof. Furthermore, the logical anchor may include default values for anchoring messages. The default values may direct a receiving IM client to anchor a display pane of a displayable portion of the IM client at a first line or beginning portion of a first received message including the logical anchor.

Additionally, the receiving IM client may be configured to display messages with logical anchors embedded therein in different fashions. For example, a receiving IM client may be configured to ignore logical anchors, to hold the displayable area of the IM client at the first received logical anchor and append subsequent messages below the logical anchor such that a user may scroll at his/her own pace, or simply anchor any new received messages in the viewable area upon receipt.

At a point at which a message is received, future messages containing a logical anchor may be interpreted as to not override the initial display preference set forth by the message sender. There may be included two configurable options at either a sending or receiving client. A first option may include suspension of subsequent anchors or anchor selection options of a sending client if a user of a receiving client has not scrolled to a final line of a final received message, as to prevent messages from being missed. To recognize a user's scrolling status, the messaging clients may exchange data using any existing framework for state communication. A second option may include suspension of anchor determination and display preferences, or discontinued processing of anchor tags, until the receiving user is at the bottom of the ongoing conversation. For example, all messages may be appended to the conversation as usual until the receiving user is has read all messages.

In addition to example embodiments described above with regards to logical anchors with a possible default configuration of anchoring a received message at a top or beginning portion of a message only, it is respectfully submitted that additional anchors may be used. For example, an anchor may be configured to anchor a message at any point. Such an anchor may be configured to anchor a message at a receiving IM client at a particular portion of the message. For example, a portion of a message which is determined to be important within the context of upper portions of a message, may be anchored below the viewable area of a receiving IM client. Therefore, although the above description provides for a receiving IM client to display anchored portions of a message, the converse may also be true. Thus logical anchors may be divided into “display text anchors” and/or “hide-text anchors”. One anchor may be used per message, or a combination of anchors may be used to ensure that either the entire beginning portion is shown while also insuring a subsequent portion is obscured. Examples of such messages may include solutions to questions such as math equations, punch-lines of jokes, and/or any other suitable message. To facilitate these alternate logical anchors, additional configuration settings may be provided at an IM client.

For example, as illustrated in FIG. 2, a current message for transmission 201 is illustrated. According to one example embodiment, the transmit button 205 embeds a logical anchor directing a receiving IM client to anchor the message 201 at a default/first or upper portion of the message 201. Alternatively, the transmit button 205 may embed a logical anchor configured to anchor a selected and/or viewed portion of the text of message 201 below the displayable portion of the receiving IM client. For example, the portion of message 201 within the viewable area of the user interface 200 may be anchored below the viewable area of user interface 300. Alternatively, a user may highlight or select portions of text in which to embed an anchor. In this manner, the transmit button 205 may function as an “anchor” or “anchor viewable text” button configured to embed an anchor configured to obscure text viewable to a transmitting user. This may prove useful if the transmitting user of user interface 200 desires that a message be truncated even if the message may be completely viewed at a receiving IM client. For example, if a question/answer message is transmitted, or if a joke is transmitted, which is entirely displayable at a receiving IM client, the receiving user may view a desired portion first only, thereby facilitating the intended readability of the message.

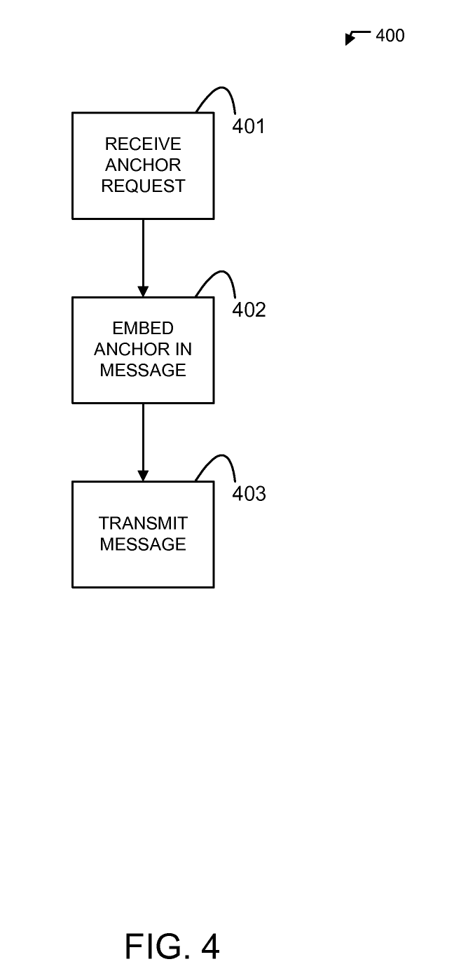

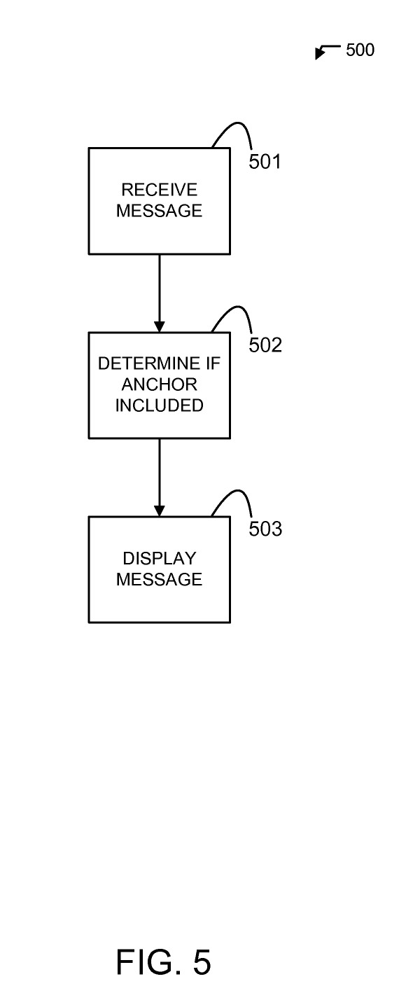

Hereinafter methods of transmission and receipt of instant messages are described in detail with reference to FIGS. 4-5.

FIG. 4 is a method of transmitting an instant message, according to an example embodiment. The method 400 may include receiving an anchor message request at block 401. For example, the anchor message request may be issued by a user of an IM client with a user interface somewhat similar to the user interface 200.

The method 400 may further include embedding a logical anchor in a current message at block 402. For example, the current message may be a message compiled by a user of the transmitting IM client. The anchor may be configurable such that either a top of the message be anchored at a receiving end such that non-displayable portions are truncated from a displayable area of a receiving IM client, such that a portion of the message displayed at the transmitting IM client is anchored below the displayable area of the receiving IM client, or such that a portion of the message displayed at the transmitting IM client is anchored above the non-displayable area of the receiving IM client. The anchor may be a code portion embedded within the message. For example, the code portions may be included in a message header, footer, trailer or within the message itself as any suitable form of code. If embedded within the message itself, the logical anchor may be embodied as control characters or simple code blocks marking or surrounding (i.e., beginning or beginning and end) either displayable text, truncated text, or any combination thereof.

Finally, the method 400 includes transmitting the anchored message at block 403. For example, the message may be transmitted over a communication medium in communication with a computer apparatus executing the transmitting IM client. The communication medium may also be in communication with the receiving IM client. For example, the communication medium may be any suitable medium including, but not limited to, the Internet, a local area network, a wide area network, a cellular telephone or digital telephony network, a digital packet communication network, or any combination thereof. Upon transmission of the message including any suitable delay, it follows that an intended receiving IM client receives the transmitted message as described in FIG. 5.

FIG. 5 is a method of receiving an instant message, according to an example embodiment. The method 500 includes receiving a message at block 501. The received message may be an instant message transmitted from a transmitting IM client. The instant message may include an embedded logical anchor as described above.

The method 500 may further include determining if a logical anchor is embedded within the received message at block 502. For example, the received message may be a message compiled by a user of the transmitting IM client. The anchor may be configured such that either a top of the message be anchored at a receiving end such that non-displayable portions are truncated from a displayable area of the receiving IM client, or such that a portion of the message displayed at the transmitting IM client is anchored below the displayable area of the receiving IM client. The anchor may be a code portion embedded within the message. For example, the code portions may be included in a message header, footer, trailer or within the message itself as any suitable form of code. If embedded within the message itself, the logical anchor may be embodied as control characters or simple code blocks marking or surrounding (e.g., beginning, ending, or beginning+end) either displayable text, truncated text, or any combination thereof.

Thereafter, the message may be displayed in response to the determining at block 503. For example, depending upon the configuration of the anchor (if determined to include an anchor), the received message may be displayed on a viewable area of the receiving IM client at anchor points described within the anchor. More clearly, if the embedded anchor is configured to anchor text at the beginning of the received message, the beginning portion of the message is displayed with any subsequent portions being truncated as necessary depending upon the size of the viewable area of the receiving IM client. If the embedded anchor is configured to anchor text which is requested to be obscured, the anchored text is not displayed in the viewable area of the receiving IM client, and non-anchored text is displayed in the viewable area with any previous portions being truncated above the viewable area as necessary depending upon the size of the viewable are of the receiving IM client.

Therefore, as described above, example embodiments of the present invention provide methodologies which enhance the transmission and receipt of instant messages. It is noted however that although example embodiments have been described according to instant messaging clients only, these embodiments are applicable to any message transmission technology. For example, short messaging service (SMS) text messages are becoming increasingly popular. However, as is known, SMS messages are currently limited to only 160 characters. Further any messages received subsequent to a first message may be displayed upon receipt. However, upon embedding logical anchors as described herein, subsequent messages may be held in queue or obscured as necessary at a receiving device such that messages are read as intended by a transmitting device/user.

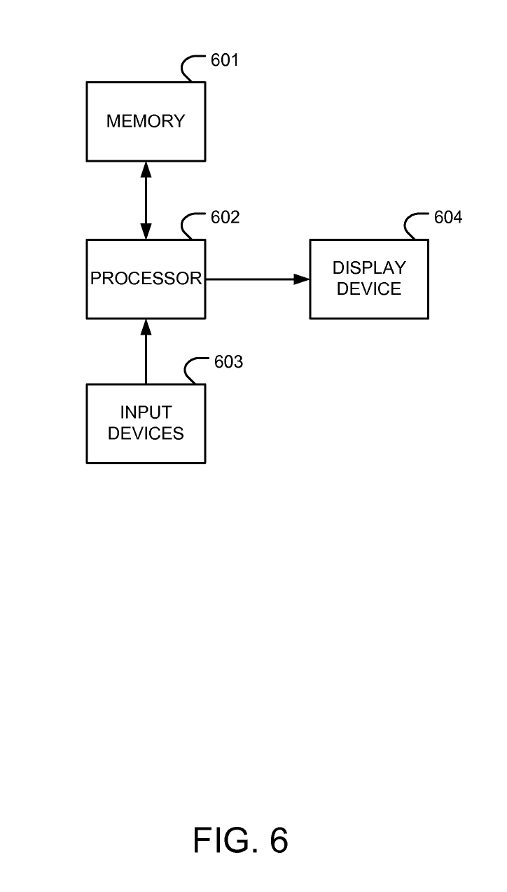

Therefore, the methods described herein provide enhanced messaging across a variety of platforms including instant messaging clients and SMS clients. Additionally, the methodologies and systems of example embodiments of the present invention may be implemented in hardware, software, firmware, or a combination thereof. For example, according to an exemplary embodiment, the methodologies described hereinbefore may be implemented by a computer system or apparatus. For example, FIG. 6 illustrates a computer apparatus, according to an exemplary embodiment. Therefore, portions or the entirety of the methodologies described herein may be executed as instructions in a processor 602 of the computer system 600. The computer system 600 includes memory 601 for storage of instructions and information, input device(s) 603 for computer communication, and display device 604. Thus, the present invention may be implemented, in software, for example, as any suitable computer program on a computer system somewhat similar to computer system 600. For example, a program in accordance with the present invention may be a computer program product causing a computer to execute the example methods described herein.

The computer program product may include a computer-readable medium having computer program logic or code portions embodied thereon for enabling a processor (e.g., 602) of a computer apparatus (e.g., 600) to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks, cassette tapes, and removable hard disks; media with a built-in rewriteable non-volatile memory such as memory cards; and media with a built-in ROM, such as ROM cassettes.

Further, such programs, when recorded on computer-readable storage media, may be readily stored and distributed. The storage medium, as it is read by a computer, may enable the method(s) disclosed herein, in accordance with an exemplary embodiment of the present invention.

While the invention is described with reference to an exemplary embodiment, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited the embodiments disclosed for carrying out this invention, but that the invention includes all embodiments falling with the scope of the appended claims. Moreover, the use of the terms first, second, etc. does not denote any order of importance, but rather the terms first, second, etc. are used to distinguish one element from another.

1. A method of enhanced message transmission, comprising:
receiving an anchor message request, the anchor message request referring to a message for transmission;
embedding a logical anchor in the message for transmission to form an anchored message, the logical anchor referring to a portion of the message for transmission to be anchored inside or outside a displayable area of a messaging client; and
transmitting the anchored message.

2. The method of claim 1, wherein the anchor message request is issued by a user of a transmitting messaging client, to the transmitting messaging client.

3. The method of claim 1, wherein the logical anchor is configured such that a beginning portion of the anchored message is displayed first at a receiving messaging client.

4. The method of claim 1, wherein the logical anchor is configured such that a portion of the message for transmission displayed at the transmitting messaging client is not displayed at a receiving messaging client.

5. The method of claim 1, wherein the logical anchor is configured such that a portion of the message for transmission not displayed at the transmitting messaging client is displayed at a receiving messaging client.

6. The method of claim 1, wherein the logical anchor is a segment of computer code embedded within the message for transmission.

7. The method of claim 6, wherein the segment of computer code is embedded within a header, trailer, or footer of the anchored message.

8. The method of claim 6, wherein the segment of computer code is included within text of the anchored message.

9. The method of claim 8, wherein the segment of computer code includes control characters marking a beginning of displayable text or non-displayable text.

10. The method of claim 8, wherein the segment of computer code includes computer executable code referring to displayable text or non-displayable text.

11. The method of claim 8, wherein the segment of computer code includes control characters surrounding displayable text or non-displayable text.

12. A method of enhanced message receipt, comprising:
receiving a message at a messaging client;
determining if a logical anchor is embedded within the received message, the logical anchor referring to a portion of the received message to be anchored inside or outside a displayable area of the messaging client; and
displaying the received message in response to the determining.

13. The method of claim 12, wherein the received message includes an embedded logical anchor.

14. The method of claim 13, wherein the logical anchor is configured such that a beginning portion of the received message is displayed first at the messaging client.

15. The method of claim 13, wherein the logical anchor is configured such that an ending portion of the received portion is displayed first at the messaging client.

16. The method of claim 1, wherein the logical anchor is a segment of computer code embedded within the received message.

17. The method of claim 16, wherein the segment of computer code is embedded within a header, trailer, or footer of the received message.

18. The method of claim 16, wherein the segment of computer code is included within text of the received message.

19. The method of claim 18, wherein the segment of computer code includes control characters marking a beginning of displayable text or non-displayable text.

20. The method of claim 18, wherein the segment of computer code includes computer executable code referring to displayable text or non-displayable text.

21. The method of claim 18, wherein the segment of computer code includes control characters surrounding displayable text or non-displayable text.

22. A computer readable storage medium including computer executable instructions that, when executed on a computer processor, direct the computer processor to perform a method of enhanced message transmission, comprising:
receiving an anchor message request, the anchor message request referring to a message for transmission;
embedding a logical anchor in the message for transmission to form an anchored message, the logical anchor referring to a portion of the message for transmission to be anchored inside or outside a displayable area of a messaging client; and
transmitting the anchored message.

23. A computer readable storage medium including computer executable instructions that, when executed on a computer processor, direct the computer processor to perform a method of enhanced message receipt, comprising:
receiving a message at a messaging client;
determining if a logical anchor is embedded within the received message, the logical anchor referring to a portion of the received message to be anchored inside or outside a displayable area of the messaging client; and
displaying the received message in response to the determining.
